(19) United States
(12) Patent Application Publication
(10) Pub. No.: US 2010/0199095 A1
(43) Pub. Date: Aug. 5, 2010

(54) Password-Authenticated Association Based on Public Key Scrambling

(75) Inventor: Jin-Meng Ho, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INC., Dallas, TX (US)

(21) Appl. No.: 12/697,113

(22) Filed: Jan. 29, 2010

Related U.S. Application Data
(60) Provisional application No. 61/148,625, filed on Jan. 30, 2009.

(51) Int. Cl. H04L 9/32

(52) U.S. Cl. 713/171

(57) ABSTRACT

A system and method for establishing a mutual entity authentication and a shared secret between two devices using a password without giving any useful information for finding the password is disclosed. Unique first private keys and first public keys are assigned to both devices. A shared password is provided to both devices. The public keys are scrambled using the shared password and then exchanged between the two devices. Both devices descramble their respectively received scrambled public keys using the shared password to recover the public keys. Both devices compute a shared secret from their own private keys and the recovered public keys. Both devices compute, exchange, and verify their hashes of the shared secret. If verification is successful, both devices use the shared secret to generate a shared master key, which is used either directly or via a later-generated session key for securing message communications between the two devices.

### CROSS-REFERENCE TO RELATED APPLICATIONS

The present application claims the benefit of the filing date of U.S. Provisional Patent Application No. 61/148,625 which is titled “Password-Authenticated Association Based on Public Key Scrambling” and was filed Jan. 30, 2009, the disclosure of which is hereby incorporated by reference herein in its entirety.

### TECHNICAL FIELD

Embodiments of the invention are directed, in general, to network security and, more specifically, to using a password for authenticated key exchange, establishment, or association.

### BACKGROUND

Message exchanges between two or more parties in a wireless network or over the Internet are vulnerable to eavesdropping and manipulation by other parties. Security is required to protect the confidentiality and integrity of the message exchanges. Typically, messages are protected through encrypting and authenticating the messages with a shared session key between the intended parties. A shared session key is often derived from a shared master key (MK) that is rarely used and, therefore, the shared master key is more tightly guarded against potential compromise.

It is often inconvenient or impossible to manually install or reinstall a shared session key or master key of sufficient length into the parties' desired communication. The Diffie-Hellman key exchange protocol, which is based on public key cryptography, allows two parties not previously known to each other to establish a shared secret by openly exchanging their public keys. The shared secret can be used to derive a shared master key and/or session key. The shared secret remains a secret between the two communication parties even in presence of third-party eavesdroppers, provided the protocol parameters are chosen appropriately.

In particular, after the exchange of their public keys but not private keys, both parties create a shared secret (SS) based on their respective private keys (a, b) and received public keys (B, A). The shared secret can then be used to create a master key and/or session key for securing future communications between the two parties. A third party, such as an eavesdropper, with access to the public keys of the two parties cannot recreate the shared secret (SS) because the third party does not have the other parties' private keys (a, b).

The Diffie-Hellman key exchange, nevertheless, is susceptible to impersonation and man-in-the middle attacks. A third-party imposter can impersonate one of the two legitimate parties, exchanging public keys and hence establishing a shared secret with the other, without the latter knowing the truth. While the two legitimate parties start exchanging their public keys, a third party can also intercept their messages and inject its own messages to impersonate both of the sending parties separately. Thus, the two legitimate parties unknowingly communicate with the malicious third party instead of each other as they believe.

To thwart such attacks, entity authentication is introduced into the key exchange between two communicating parties, to ensure that each is communicating with the expected or claimed other party but not an imposter. Using a shared password for entity authentication has been widely used. It is much more convenient to share a relatively short password than a long secret key between two parties. However, many password-based authentication protocols are vulnerable to offline dictionary attacks. For example, when a claimant attempts to corroborate its identity to a verifier by sending a message showing knowledge of the password, a third party impersonating the verifier can record the message and thereafter do a password search in the short password space against that message.

For example, in some known protocols for password-authenticated key association, two parties first exchange their public keys to create a shared secret, and then exchange hashes of the shared secret and password to corroborate their identify to each other by demonstrating knowledge of the password. The inclusion of the shared secret in the hash of the password prevents an eavesdropper from searching for a matching password against the overheard hash, since the hash is also a function of the shared secret to which the eavesdropper is not privy. However, such two-step protocols still allow an imposter who has established the shared secret that is used in the subsequent password hash to run an offline dictionary attack in the one-dimensional small password space against the received hash.

Key exchange protocols with strong password authentication or zero-knowledge password authentication have been discovered that make offline dictionary attacks difficult or infeasible. However, they appear to be either exposed to other security attacks, such as partition and subgroup confinement attacks, or resource- and power-hungry. Therefore, what is needed, especially for power sensitive and resource constrained devices, is new password-authenticated key agreement protocols that are simple in message computation and communication but strong in the desired security and functionality.

The term “party” as used herein will be understood to include devices, such as nodes and hubs communicating in a subnet, as well as individual users. The following terms are also meant to be synonymous: key exchange, key agreement, key establishment, and association. Also interchangeable are method, protocol, procedure, and process.

### SUMMARY OF THE INVENTION

Embodiments of the invention use a password to scramble the public keys exchanged between two parties. The parties use their knowledge of the password to recover the other party's public key. Each party uses its own private key and the other party's recovered public key to compute a shared secret. Both parties then hash their computed shared secret and send the hash to each other. The hash sent out by one party is a function of both the password and the private key of that party, which is not known to any other party. No other party, be it an eavesdropper or imposter, can use the hash to reversely search the password in a relatively small password space. The search would have to be performed in the password space augmented by the private key space, which by design is very large. This requires an attacker to guess in two dimensions: the password space and the private key space. Therefore, the scheme allows for the setup of a shared secret key between two strangers while providing mutual authentication, without being subject to offline dictionary attacks that have often plagued password authentication protocols.

In one embodiment, a first device and a second device establish a shared master key. The first device has a first private key and a first public key, and the second device has a second private key and a second public key. Both devices have a shared password. The first device scrambles the first public key using the shared password to create a scrambled first public key, which it sends to the second device. Similarly, the second device scrambles the second public key using the shared password to create a scrambled second public key, which it sends to the first device. The second device unscrambles the scrambled first public key using the shared password to create a recovered first public key. The second device computes a first shared secret device using the recovered first public key and the second private key. The second device then computes a first and a second hash of the first shared secret and sends the first hash of the first shared secret to the first device. The first device unscrambles the scrambled second public key using the shared password to create a recovered second public key. The first device then computes a second shared secret using the recovered second public key and the first private key. The first device computes a first and a second hash of the second shared secret and compares the first hash of the first shared secret received from the second device to the first hash of the second shared secret computed by the first device itself. If the comparison matches, then the first device sends the second hash of the second shared secret to the second device, which then compares the second hash of the second shared secret received from the first device to the second hash of the first shared secret computed by the second device itself. After verifying by both devices that the hash comparisons match, the devices compute a shared master key from the shared secret.

The first and second devices may also compute authentication check parameters using the shared secret and nonces selected independently by both devices. The devices may exchange the authentication check parameters to verify that the devices each possess the same password during the password-scrambled key exchange. The devices may use a discrete logarithm or an elliptic curve discrete logarithm for the public key computation and exchange. The devices may use cipher-based message authentication code (CMAC) or hash-based message authentication code (HMAC) algorithms to compute the authentication check parameters.

### BRIEF DESCRIPTION OF THE DRAWINGS

Having thus described the invention in general terms, reference will now be made to the accompanying drawings, wherein:

FIG. 1 illustrates a general procedure for creating a master key using a password-scrambled key exchange;

FIG. 2 illustrates an exemplary realization of the general procedure of FIG. 1 based on a discrete logarithm according to one embodiment of the invention;

FIG. 3 illustrates an exemplary realization of the general procedure of FIG. 1 based on an elliptic curve discrete logarithm according to one embodiment of the invention;

FIGS. 4A and 4B illustrate a detailed password-authenticated association procedure according to an exemplary embodiment;

FIG. 5 illustrates an exemplary association frame that is exchanged between two parties to activate a pre-shared MK or generate a new shared MK;

FIG. 6 illustrates additional fields for the association frame in FIG. 5;

FIG. 7 is a block diagram illustrating a network topology employing embodiments of the invention; and

FIG. 8 is a block diagram of an exemplary embodiment of a device for providing communications using password-authenticated association based on public key scrambling.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

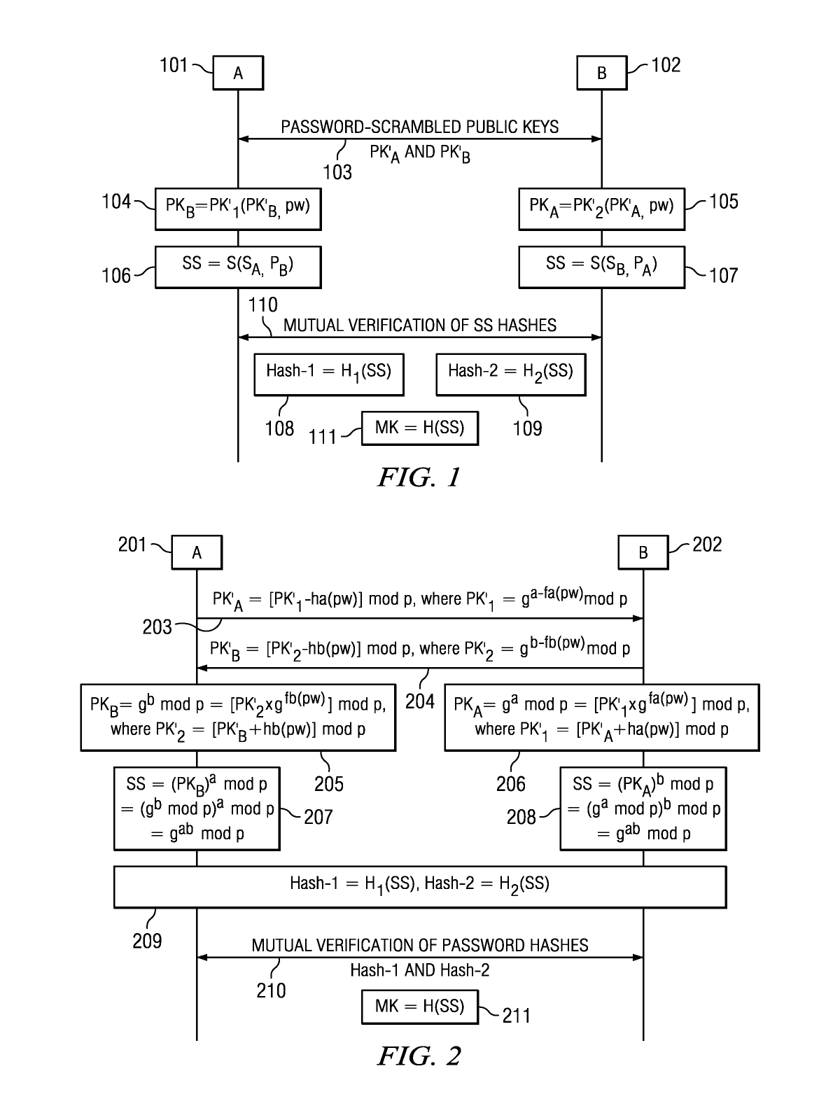

FIG. 1 illustrates a general procedure for creating a master key using a password-scrambled key exchange (PSKE) according to an exemplary embodiment of the invention. Parties A (101) and B (102) having public keys PK_{A}, PK_{B}, respectively, first exchange password-scrambled public keys PK′_{A}, PK′_{B} (103), and then descramble them using the knowledge of the password (pw) (104, 105) as symbolically given below,

PK_{B}=PK′₁(PK′_{B},pw), (1)

and

PK_{A}=PK′₂(PK′_{A},pw). (2)

Subsequently, parties A (101) and B (102) each compute a shared secret SS (106, 107) based on their own private or secret keys (S_{A}, S_{B}) and the recovered public keys (PK_{B}, PK_{A}) as symbolically given below:

SS=S(S_{A},PK_{B}), (3)

and

SS=S(S_{B},PK_{A}). (4)

The shared secret is a function of a private key and a descrambled public key which in turn depends on the password. An eavesdropper or imposter would need to simultaneously guess both the password and the private key in order to find the matching password, which by design is infeasible.

Parties A (101) and B (102) now compute and send their respective hashes (108, 109) of the shared secret given symbolically below:

Hash-1=H₁(SS), (5)

and

Hash-2=H₂(SS). (6)

If Party A first sends its scrambled public key to party B, party B may send its scrambled public key to party A along with its computed hash Hash-2, followed by party A sending its hash Hash-1 to party B. Alternatively, party A sends its hash Hash-1 to party B, and then party B sends its hash Hash-2 to party A. Party A or B sends its hash only after the hash it received from the other party has been verified valid.

Parties A (101) and B (102) then each verify their received hashes against their corresponding computed hashes (110). If the verification succeeds, they proceed to compute their shared master key as follows (111):

MK=H(SS) (7)

FIG. 2 illustrates an exemplary realization of the general procedure of FIG. 1 based on a discrete logarithm according to one embodiment of the invention. Parties A 201 and B 202 exchange password-scrambled public keys (PK′_{A}, PK′_{B}) in messages 203 and 204, respectively. The password-scrambled public keys (PK′_{A}, PK′_{B}) are generated from the corresponding public keys (PK_{A}, PK_{B}) and private keys (a, b) and the password pw as follows:

PK′_{A}=[PK′₁−ha(pw)] mod p, (8)

where PK′₁=PK_{A}×g^{fa(pw)} mod p, PK_{A}=g^{a} mod p; and (9)

PK′_{B}=[PK′₂−hb(pw)] mod p, (10)

where PK′₂=PK_{B}×g^{fb(pw)} mod p, PK_{B}=g^{b} mod p. (11)

Parties A and B then unscramble the password-scrambled public keys in steps 205, 206. The unscrambled public keys (PK_{A}, PK_{B}) are obtained using the following formulas:

PK_{B}=PK′₁(PK′_{B},pw)=[PK₂×g^{fb(pw)}] mod p=g^{b} mod p, (12)

where PK₂=[PK′_{B}+hb(pw)] mod p; and (13)

PK_{A}=PK′₂(PK′_{A},pw)=[PK₁×g^{fa(pw)}] mod p=g^{a} mod p, (14)

where PK₁=[PK′_{A}+ha(pw)] mod p. (15)

Here, “g” is a base number known to both parties, and “p” is a prime number also known to both parties; “a” is party A's private key, and “b” is party B's private key; “mod p” denotes modular p operation.

Using the unscrambled public keys, parties A and B each compute a shared secret SS (207, 208) based on their own private or secret keys (a, b) and the recovered public keys (PK_{B}, PK_{A}) using the following formulas:

for party A,

SS=(PK_{B})^{a} mod p=(g^{b} mod p)^{a} mod p=g^{ab} mod p; (16)

and for party B,

SS=(PK_{A})^{b} mod p=(g^{a} mod p)^{b} mod p=g^{ab} mod p. (17)

Using equations (5) and (6) given above in FIG. 1, parties A and B then compute and send their respective hashes (209) of the shared secret. Parties A and B then each verify the received hash from the other party against their corresponding computed hash (210). If the verification succeeds, they proceed to compute (211) their shared master key (MK) using equation (7) as given above.

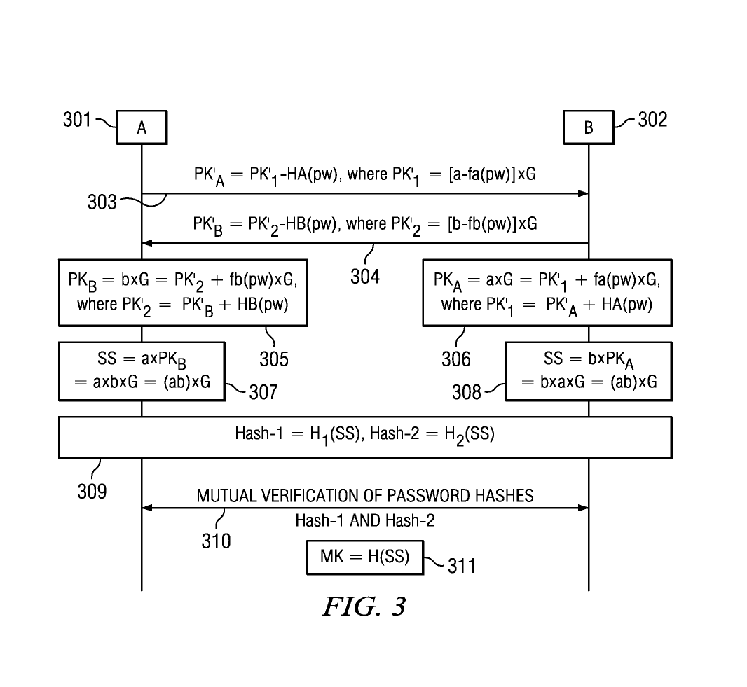

FIG. 3 illustrates an exemplary realization of the general procedure of FIG. 1 based on an elliptic curve discrete logarithm according to another embodiment of the invention. The formulas corresponding to those for FIG. 1 and FIG. 2 are also shown in FIG. 3. In particular, the password-scrambled public keys (PK′_{A}, PK′_{B}) are generated from the corresponding public keys (PK_{A}, PK_{B}) and private keys (a, b) and the password pw as follows:

PK′_{A}=PK′₁−HA(pw), (18)

where PK′₁=PK_{A}−fa(pw)×G, PK_{A}=a×G; and (9) (19)

PK′_{B}=PK′₂−HB(pw), (20)

where PK′₂=PK_{B}−fb(pw)×G, PK_{B}=b×G. (21)

Here, “G” is a base point on an elliptic curve that serves as a generator to generate other points on the elliptic curves; it is known to both parties. HA(pw) and HB(pw) are elliptic curve points generated from the password, and are on the same elliptic curve as the base point “G”. The symbol “×” denotes scalar multiplication of an integer with an elliptic curve point, such as the base point G.

Similar to the implementations in FIGS. 1 and 2, parties 301 and 302 generate and exchange password-scrambled public keys (PK′_{A}, PK′_{B}) in messages 303 and 304, respectively. Parties A and B then unscramble the password-scrambled public keys in steps 305, 306. Parties A and B each compute a shared secret SS (307, 308) based on their own private or secret keys (a, b) and the recovered public keys (PK_{B}, PK_{A}). The parties then compute and send their respective hashes (309) of the shared secret. Parties A and B then each verify the received hash from the other party against their corresponding computed hash (310). If the verification succeeds, both parties compute (311) their shared master key (MK).

The functions used to scramble and unscramble the public keys in FIG. 2 and FIG. 3 are subject to the following constraints:

ha(pw)≠0, HA(pw)≠O, (22)

if party B is the first party to send a password hash; or

hb(pw)≠0, HB(pw)≠O, (23)

if party A is the first party to send a password hash.

For example, if hb(pw)=0 or HB(pw)=O, then (i) the shared secret (SS) computed by party A would degenerate to a function of the password (pw) and g^{a} in FIG. 2 or of pw and a×G in FIG. 3, and (ii) g^{a} or a×G could be extracted as a function of the password (pw) from the received party A's scrambled public key. Thus, the hash computed and sent by party A would be a function of the password but not the private key of party A. This would allow an imposter standing in the place of party B to do an offline dictionary attack in the password space.

The password scrambled key exchange protocols disclosed herein require virtually no additional complexity in computing the scrambled public key for transmission. Marginal complexity is required to recover a public key, but the system prevents off-line dictionary attacks in the password space. An attacker can only make one password guess on each run of a protocol disclosed herein, as is always possible with any password authentication protocol.

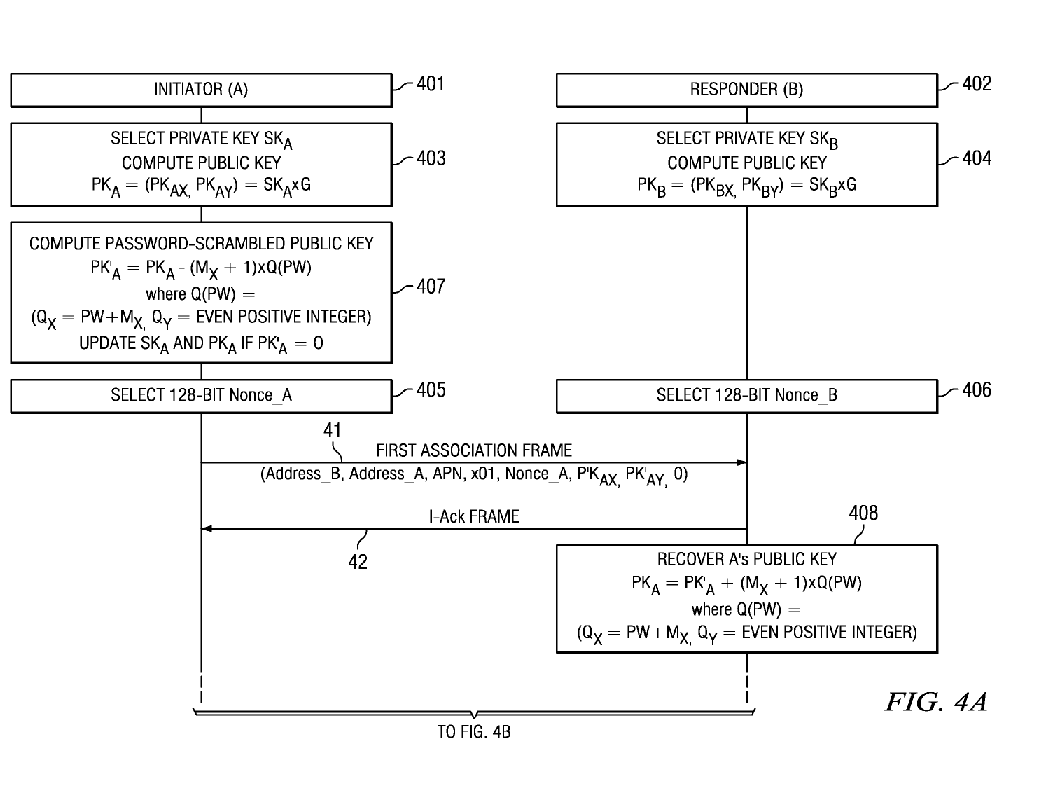

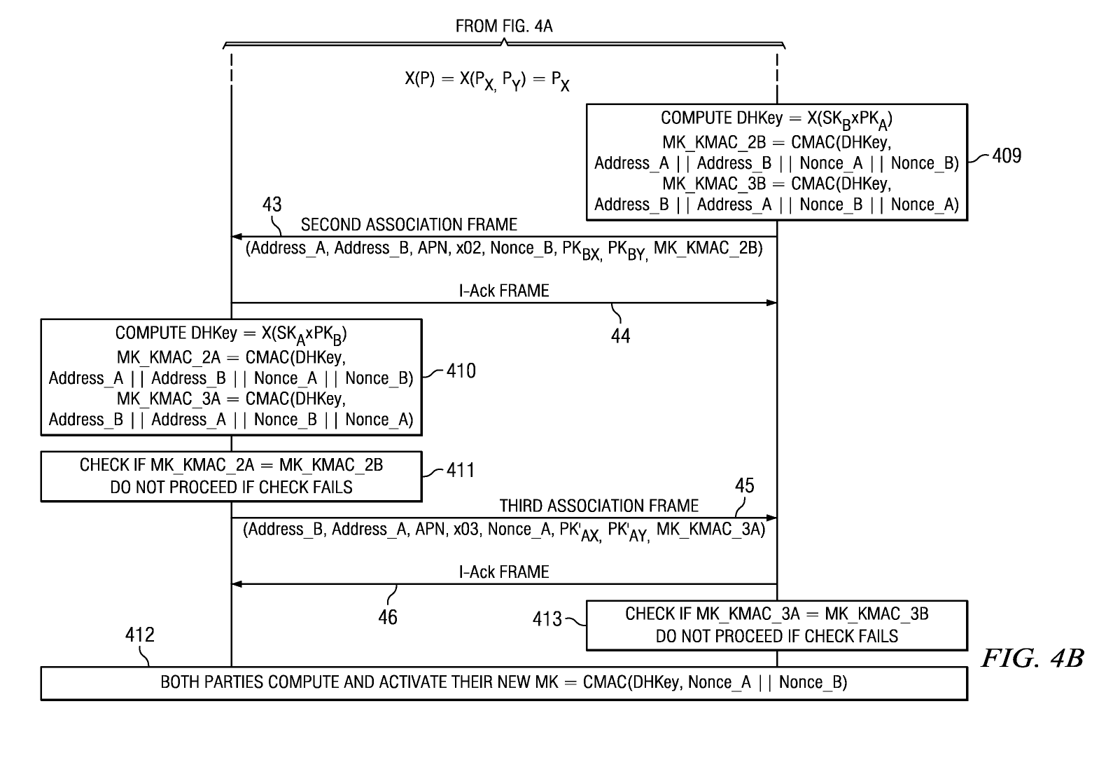

FIGS. 4A and 4B illustrates a detailed password-authenticated association procedure according to an exemplary embodiment. The procedure is started by Initiator 401. Both Initiator 401 and responder 402 select a private key (SK_{A}, SK_{B}) and compute a public key (PK_{A}, PK_{B}) in steps 403, 404, respectively. In one embodiment, the private keys are a 192-bit integer, and the public keys are pair of 192-bit X and Y coordinates of points on an elliptic curve over a finite field.

Both Initiator 401 and responder 402 have a shared secret password (PW) to run a password-authenticated association protocol to generate a shared master key (MK). Initiator 401 and responder 402 independently generate a new 128-bit cryptographic random number as a Nonce for use in the association procedure (405, 406).

In the example of FIGS. 4A and 4B, Initiator 401 and responder 402 use a password-scrambled key exchange based on an elliptic curve discrete logarithm, such as the elliptic curve discrete logarithm described in FIG. 3, to derive the shared master key. In one embodiment of the invention, the elliptic curve is characterized by the equation:

y²=x³+ax+b mod p, a,bεGF(p), 4a³+27b²≠0, (24)

where GF(p) is a prime finite field. In an exemplary embodiment, the equation has the following values for its coefficients and domain parameters, as specified for Curve P-192 in Federal Information Processing Standard Publication (FIPS PUB) 186-2, with “p” (an odd prime), “r” (order of base point G), and “a” (a coefficient) given in decimal form, and coefficient “b” and base point “G”=(Gx, Gy) given in hex:

p=6277101735386680763835789423207666416083908700390324961279

r=6277101735386680763835789423176059013767194773182842284081

a=−3 mod p

b=64210519 e59c80e7 0fa7e9ab 72243049 feb8deec c146b9b1

Gₓ=188da80e b03090f6 7cbf20eb 43a18800 f4ff0afd 82ff1012

G_{Y}=07192b95 ffc8da78 631011ed 6b24cdd5 73f977a1 1e794811

The private keys SK_{A} and SK_{B} for Initiator 401 and Responder 402 are, in an exemplary embodiment, unique 192-bit integers in the range [1, r−1]. The corresponding 192-bit public keys PK_{A} and PK_{B} are computed as follows:

PK_{A}=SK_{A}×G, PK_{B}=SK_{B}×G, (25)

where “×” denotes scalar multiplication of the base point G=(Gₓ, G_{Y}) by an integer (a private key) as described in A.9.2 of IEEE Std P1363-2000. A public key, denoted by a pair of X-coordinate and Y-coordinate values, is treated as valid only if it is a non-infinity point on the elliptic curve defined above (i.e. its X and Y coordinates satisfy the elliptic curve equation given above).

In step 407, Initiator 401 computes its password-scrambled public key PK′_{A}=(PK′_{AX}, PK′_{AY}) using its public key (PK_{A}) or private key (SK_{A}) and the password (PW) shared with Responder 402 as follows:

PK′_{A}=PK_{A}−(M_{X}+1)×Q(PW)=SK_{A}×G−(M_{X}+1)×Q(PW), (26)

where Q(PW)=(Q_{X}=PW+M_{X}, Q_{Y}=even positive integer). (27)

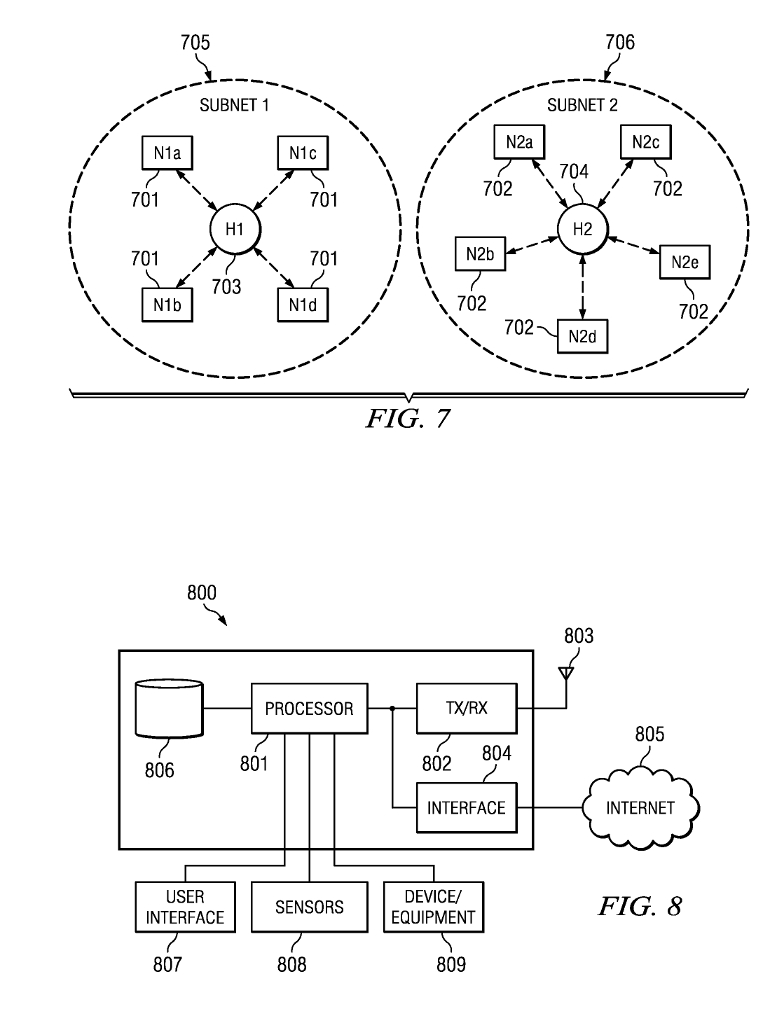

To initiate a procedure for the password-authenticated association protocol, Initiator 401 transmits a first Association frame 41 of the procedure to Responder 402. The Association frame may be of the format described in further detail below and illustrated in FIGS. 7 and 8, for example. In addition to address and administrative parameters, the first Association frame 41 includes the Initiator's nonce (Nonce_A) and the components of the Initiator's password-scrambled public key (PK′_{AX}, PK′_{AY}). Responder 402 may acknowledge receipt to first Association frame 41 by sending acknowledgement frame 42.

In step 408, Responder 402 recovers the Initiator's unscrambled public key from the received password-scrambled public key PK′_{A}=(PK′_{AX}, PK′_{AY}) using the formula:

PK_{A}=PK′_{A}+(M_{X}+1)×Q(PW), (28)

where Q(PW)=(Q_{X}=PW+M_{X}, Q_{Y}=even positive integer). (29)

The parameters involved in equations (22)-(25) are defined below:

“PW” is a positive integer converted according to IEEE Std P1363-2000 from the UTE-16BE representation of the shared password by treating the leftmost octet as the octet containing the most-significant bits. “M_{X}” is the smallest nonnegative integer such that Q_{X}=PW+M_{X} is the X-coordinate of a point on the elliptic curve defined above in equation (20). Q(PW) is the point on the elliptic curve with X-coordinate=Q_{X} and Y-coordinate=Q_{Y} of an even positive integer. Initiator 401 chooses its private key SK_{A} such that the X-coordinate of the corresponding public key PK_{A} is not equal to the X-coordinate of (M_{X}+1)×Q(PW).

In step 409, Responder 402 computes the shared secret “DHKey” using the following equation:

DHKey=X(SK_{B}×PK_{A})=X(SK_{A}×SK_{B}×G). (30)

In step 409, Responder 402 also derives the parameters of a key message authentication check (MK_KMAC_2B, MK_KMAC_3B) using a cipher-based message authentication code (CMAC) algorithm as follows:

MK_KMAC_{—}2=CMAC(DHKey,Address_{—}A∥Address_{—}B∥Nonce_{—}A∥Nonce_{—}B), (31)

MK_KMAC_{—}3=CMAC(DHKey,Address_{—}B∥Address_{—}A∥Nonce_{—}B∥Nonce_{—}A) (32)

Here, Address_A and Address_B are the addresses for Initiator 401 and Responder 402, respectively, such as a medium access control (MAC) sublayer address. Nonce_A and Nonce_B are the nonces selected by Initiator 401 and Responder 402, respectively, in steps 403, 404.

After calculating the parameters described above, Responder 402 transmits a second Association frame 43 of the procedure to Initiator 401. The second Association frame 43 includes address and administrative information along with Nonce_B, the components of the Responder's public key (PK_{BX}, PK_{BY}), and the value of MK_KMAC_2B as calculated by the Responder. As a special case of HB(pw)=O of the general case shown in FIG. 3, the Responder here does not scramble its public key. Initiator 401 acknowledges the receipt of second Association frame 43 in acknowledgement frame 44.

In step 410, Initiator 401 recovers the Responder's unscrambled public key PK_{B}=(PK_{BX}, PK_{BY}) in the second Association frame 43. Initiator 401 then computes the shared secret DHkey using the formula:

DHKey=X(SK_{A}×PK_{B})=X(SK_{A}×SK_{B}×G), (33)

where X(P)=X(P_{X},P_{Y})=P_{X}=X-coordinate of P. (34)

The DHKey computed by Initiator 401 in (33) should have the same value as the DHKey computed by Responder 402 in (30) if both parties used the same password. Initiator 401 further calculates the values of MK_KMAC_{—}2A and MK_KMAC_{—}3A using equations (31) and (32) above with its computed DHKey in (33).

In step 411, Initiator 401 compares MK_KMAC_{—}2A (calculated by Initiator 401) to MK_KMAC_2B (sent by Responder 402) to verify that Responder 402 indeed knows the password. If MK_KMAC_{—}2A=MK_KMAC_2B in step 411, then the Initiator's public key has been scrambled and unscrambled using the same password by both parties.

If MK_KMAC_{—}2A=MK_KMAC_2B, Initiator 401 sends a third Association frame 45 to Responder 401. The third Association frame 45 includes address and administrative information along with Nonce_A, the components of the Initiator's password-scrambled public key, and the value of MK_KMAC_{—}3A as calculated by the Initiator 401. Responder 402 acknowledges the receipt of third Association frame 45 in acknowledgement frame 46.

Upon successfully sending third Association frame 45, Initiator 401 treats the Responder's identity as authenticated and the association procedure as completed. In step 412, Initiator 401 computes the shared master key (MK) from the shared secret (DHKey) using the following formula:

MK=CMAC(DHKey,Nonce_{—}A∥Nonce_{—}B) (35)

Upon receiving third Association frame 45, Responder 402 compares MK_KMAC_{—}3A to MK_KMAC_3B in step 413 to verify that the Initiator has used the correct password to scramble its public key. If MK_KMAC_{—}3A=MK_KMAC_3B, then Responder 402 treats the identity of Initiator 401 as authenticated and the association procedure completed. Using equation (35), Responder 402 then also computes the shared master key.

In the embodiment illustrated in FIGS. 4A and 4B, the cipher-based message authentication code (CMAC) algorithm as specified in NIST Special Publication 800-38B, with the AES forward cipher function under a 128-bit key as specified in FIPS Pub 197, is used to compute key message authentication codes (KMAC) and to derive the shared master key (MK). Specifically, the functional notation CMAC(K, M) represents the 128-bit output of the CMAC applied under key K to message M based on the AES forward cipher function.

It will be understood that the present invention is not limited to creating the shared master key using a cipher-based message authentication code (CMAC) algorithm. Other methods of creating a message authentication code may also be used. For example, a message authentication code based on a hash function may also be used. In an alternative embodiment, a keyed-hash message authentication code (HMAC) developed by NIST and described in FIPS publication 198 may be used with a secure hash algorithm (SHA), such as SHA-256 specified in FIPS publication 180-2, to calculate the key message authentication codes (KMAC) and shared master key (MK).

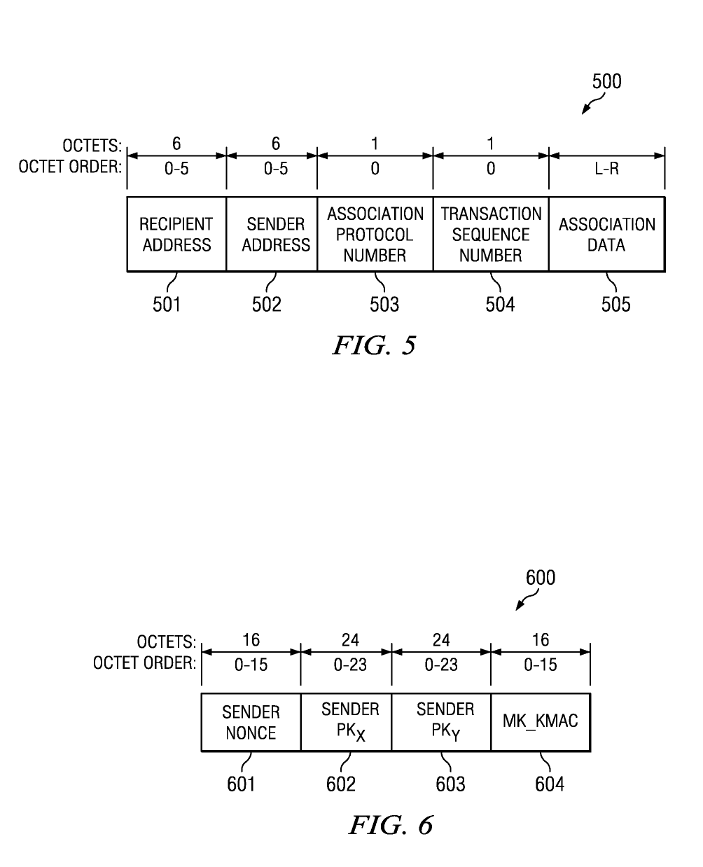

FIG. 5 illustrates data in an exemplary Association frame 500 exchanged between an Initiator and a Responder (such as a node and a hub) to activate an existing pre-shared master key or generate a new shared master key. In one embodiment, Association frame 500 may represent the payload of an Association message that includes additional medium access control and/or network routing information. It will also be understood that an association procedure may be accomplished using an Association frame having fields organized in a different manner and/or having different data. A series of messages, each comprising an embodiment of Association frame 500, may be used for a password-scrambled key exchange between two devices.

Thus, an exemplary embodiment defines the following fields comprising Association frame 500. Recipient Address field 501 is set to the medium access control (MAC) address of the recipient of the current frame. Sender Address field 502 is set to the MAC address of the sender of the current frame. Association Protocol Number field 503 is set to indicate the association protocol being used for the association. The association protocol may be, for example, a pre-shared master key (MK) association, an unauthenticated association, a public key hidden association, a password authenticated association, a display authenticated association, or other protocol. Transaction Sequence Number field 504 is set to the number (i.e., position) of the current Association frame in the series of messages for the chosen association protocol. For example, field 504 is set to 1 in the first Association frame of the protocol, 2 in the second Association frame, 3 in the third, etc. In one embodiment, the first Association frame is the Association frame transmitted by the Initiator initializing the association, the second Association frame is the Association frame transmitted by the Responder, etc.

FIG. 6 illustrates additional fields 600 within Association Data field 504 of the Association frame 500 in FIG. 5. Association Data is specific to the association protocol being used. For a password-scrambled key exchange association, such as described herein, Association Data field 505 is formatted as shown in FIG. 6. Sender Nonce field 601 is set to a statistically unique number per sender and per association procedure. The sender's nonce in field 601 may be an integer randomly drawn with a uniform distribution over the interval (0, 2¹²⁸) in one embodiment. In an association procedure in which the parties alternate sending messages, the Sender Nonce field 601 will be set to the Initator's nonce in the first and third Association frames, and set to the Responder's nonce in the second Association frames, etc.

Sender PK_{X} field 602 is set to the X-coordinate of the sender's public key. For a password-authenticated association, in the first and third Association frames of the current association procedure, field 602 is set to the X-coordinate of the Initiator's password-scrambled public key (PK′_{AX}), and in the second Association frame, field 602 is set to the X-coordinate of the Responder's public key (PK_{BX}).

Sender PK_{Y} field 603 is set to the Y-coordinate of the sender's public key. For a password-authenticated association, in the first and third Association frames of the current association procedure, field 603 is set to the Y-coordinate of the Initiator's password-scrambled public key (PK′_{A}y); and in the second Association frame, the field is set to the Y-coordinate of the Responder's public key (PK_{BY}).

Key message authentication check (MK_KMAC) field 604 is set depending upon where the frame fits within the current association procedure. For a password-authenticated association, in the first Association frame of the current association procedure, field 604 is set to 0. In the second Association frame of the procedure, field 604 is set to a KMAC calculated by the Responder if the Responder has a shared password with the sender of the first Association frame. If the Responder does not have a shared password, then MK_KMAC field 604 is set to 0. In the third Association frame of the procedure, field 604 is set to a KMAC calculated by the Initiator.

FIG. 7 is a block diagram illustrating a network topology employing embodiments of the invention. Nodes 701, 702 and hubs 703, 704 are organized into logical sets, referred to as subnets. In the illustrated embodiment, there is only one hub in a subnet, but the number of nodes in a subnet may vary. For example, subnet 1 705 comprises hub 703 and plurality of nodes 701, and subnet 2 706 comprises hub 704 and plurality of nodes 702. In one embodiment, data is exchanged directly between the nodes and their respective hub—i.e. within the same subnet only. In another embodiment of the invention, data may be exchanged between different subnets. The hub and nodes may communicate using a wireless or wireline connection. An individual node and its corresponding hub may create a master key using a password-scrambled key exchange such as those processes illustrated in FIGS. 1-4. The master key may then be used to generate a session key for use in secure communications between the node and hub.

FIG. 8 is a block diagram of an exemplary embodiment of a device 800 implementing embodiments of the invention. Device 800 may be used as a node 701, 702 and/or a hub 703, 704 in FIG. 7. In one embodiment, device 800 is a hub, gateway, or controller controlling and communicating with one or more nodes. Processor 801 processes data to be exchanged with other nodes via transceiver 802 and antenna 803 and/or via wireline interface 804 coupled to Internet or another network 805. Processor 801 may be a software, firmware, or hardware based device. Processor 801 may choose a private key (a, b) and compute a public key (PK_{A}, PK_{B}) or a password scrambled public key (PK′_{A}, PK′_{B}) from the private key. Processor 801 may compute a shared secret (SS) from a local private key (a, b) and a received or recovered public key (PK_{B}, PK_{A}). Processor 801 may also generate and process messages sent to, and received from, another device for password-authenticated key exchange. Processor 801 may further hash the shared secret (SS) to create a master key (MK). Processor 801 may further use the master key to create a session key for securing a communication session between this device and the other device.

Memory 806 may be used to store cryptographic data, such as public keys, private keys, shared secret data, master keys, session keys, passwords, and the like. For such storage, memory 806 is secured from unauthorized access. Memory 806 may also be used to store computer program instructions, software and firmware used by processor 801. It will be understood that memory 806 may be any applicable storage device, such as a fixed or removable RAM, ROM, flash memory, or disc drive that is separate from or integral to processor 801.

Device 800 may be coupled to other devices, such as user interface 807, sensors 808, or other devices or equipment 809. In one embodiment, device 800 is a low-power wireless node operating on, in, or around a human or non-human body to serve one or more applications, such as medical connections, consumer electronics, and personal entertainment. Device 800 may be adapted to operate in a body area network either as a node or as a hub controlling a plurality of nodes. Sensors 808 may be used, for example, to monitor vital patient data, such as body temperature, heart rate, and respiration. Equipment 809 may be, for example, a monitor or other device that receives and analyzes signals, such as a patient's temperature, heart rate, and respiration, from another node. Alternatively, equipment 809 may be a device for providing a service to a patient, such as controlling an intravenous drip, respirator, or pacemaker.

When used as a node or hub in a body area network, the information transmitted or received by device 800 is likely to include sensitive and/or confidential medical information. Accordingly, it is important to secure any session established by device 800 to protect the data from unauthorized parties, such as an imposter or eavesdropper. The data transmitted or received by device 800 may also include control signals, such as signals to control distribution of medicine or operation of a respirator or pacemaker. It is important that only authorized signals be used to control equipment 809 and that other signals be rejected or ignored to prevent, for example, unauthorized adjustments to drug distribution or respirator operation. Secure communications based upon a password authenticated key exchange based on public key scrambling as described earlier provide the necessary level of control for such a device.

It will be understood that the subnets 705, 706 in FIG. 7 and the device 800 in FIG. 8 are presented for illustrative purposes only and are not intended to limit the scope of the systems or devices that are capable of employing the password-scrambled key exchange procedure described herein. Any two devices in wireless or wireline communication with each other and each having its own set of private and public keys and a shared password would be capable of using the password-authenticated shared master key creation procedure.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A method of establishing a master key between a first device and a second device, the first device having a first private key and a first public key, the second device having a second private key and a second public key, and both devices having a shared password, the method comprising:
scrambling the first public key at the first device using the shared password to create a scrambled first public key;
sending the scrambled first public key to the second device;
sending the second public key to the first device;
computing a first shared secret at the first device using the second public key and the first private key;
unscrambling the scrambled first public key at the second device using the shared password to create a recovered first public key; and
computing a second shared secret at the second device using the recovered first public key and the second private key.

2. The method of claim 1, further comprising:
scrambling the second public key at the second device using the shared password to create a scrambled second public key;
wherein the second public key sent to the first device is the scrambled second public key; and
unscrambling the scrambled second public key at the first device using the shared password to create a recovered second public key;
wherein the first shared secret computed at the first device using the recovered second public key and the first private key.

3. The method of claim 1, further comprising:
computing a first and a second hash of the second shared secret at the second device;
computing a first and a second hash of the first shared secret at the first device;
exchanging the first hash of the first shared secret and the second hash of the second shared secret between the first and second devices;
verifying at the first device that the received second hash of the second shared secret matches the computed second hash of the first shared secret and at the second device that the received first hash of the first shared secret matches the computed first hash of the second shared secret; and
computing the master key from the shared secret at the first and second devices.

4. The method of claim 1, wherein the method is based on discrete logarithm.

5. The method of claim 1, wherein the method is based on elliptic curve discrete logarithm.

6. The method of claim 3, wherein the first and second hashes of the first shared secret and the first and second hashes of the second shared secret are computed as message authentication check parameters based on a cipher-based message authentication code (CMAC) algorithm.

7. The method of claim 3, wherein the first and second hashes of the first shared secret and the first and second hashes of the second shared secret are computed as message authentication check parameters based on a keyed-hash message authentication code (HMAC) algorithm.

8. The method of claim 3, wherein computing the first and second hashes of the first shared secret and the first and second hashes of the second shared secret further comprises:
using a first nonce selected by the first device, a second nonce selected by the second device, an address of the first device, and an address of the second device.

9. The method of claim 3, wherein the first device sends the first hash of the first shared secret to the second device only if it has verified that the received second hash of the second shared secret matches the computed second hash of the first shared secret.

10. The method of claim 3, wherein the second device sends the second hash of the second shared secret to the first device only if it has verified that the received first hash of the first shared secret matches the computed first hash of the second shared secret.

12. A method of establishing a shared master key between devices, the devices each having a private key, a public key, and a shared password, comprising:
scrambling a public key using the shared password to create a first scrambled public key;
sending the first scrambled public key to another device;
receiving a second public key from the other device; and
computing a first shared secret using the second public key and a first private key.

13. The method of claim 12, wherein the second public key received from the other device is a second scrambled public key, the method further comprising:
unscrambling the second scrambled public key using the shared password to create a recovered second public key; and
wherein the first shared secret is computed using the recovered second public key and the first private key.

14. The method of claim 12, further comprising:
computing a first and a second hash of the first shared secret;
sending the first hash of the first shared secret to the other device;
receiving a second hash of a second shared secret from the other device;
verifying that the received second hash of the second shared secret matches the computed second hash of the first shared secret; and
computing the master key from the shared secret.

15. The method of claim 12, wherein the method is based on discrete logarithm.

16. The method of claim 12, wherein the method is based on elliptic curve discrete logarithm.

17. The method of claim 14, wherein the first and second hashes of the first shared secret and the first and second hashes of the second shared secret are computed as message authentication check parameters based on a cipher-based message authentication code (CMAC) algorithm.

18. The method of claim 14, wherein the first and second hashes of the first shared secret and the first and second hashes of the second shared secret are computed as message authentication check parameters based on a keyed-hash message authentication code (HMAC) algorithm.

19. The method of claim 14, wherein computing the first and second hashes of the first shared secret and the first and second hashes of the second shared secret further comprises:
using a first nonce selected by the first device, a second nonce selected by the other device, an address of the first device, and an address of the other device.

20. The method of claim 14, wherein sending the first hash of the first shared secret to the other device occurs after receiving the second hash of the second shared secret from the other device and verifying that the received second hash of the second shared secret matches the computed second hash of the first shared secret.

21. The method of claim 14, wherein sending the first hash of the first shared secret to the other device occurs before receiving the second hash of the second shared secret from the other device.

22. A device, comprising:
a circuit for sending signals to and receiving signals from another device;
a memory for storing a device public key, a device private key, and a shared password; and
a processor adapted to perform operations on the signals sent to or received from the other device, the processor operating to:
scramble the device public key using the shared password to create a first scrambled public key;
generate a message comprising the first scrambled public key, the message adapted to be sent to the other device;
process a received message comprising a second public key, the message received from the other device; and
compute a first shared secret using the second public key and the device private key.

23. The device of claim 22, wherein the received messages comprises a second scrambled public key, and the processor further operating to:
unscramble the second scrambled public key using the shared password to create a recovered second public key; and
compute the first shared secret using the recovered second public key and the device private key.

24. The device of claim 22, the processor further operating to:
compute a first and second hash of the first shared secret;
generate a message containing the first hash of the first shared secret, the message adapted to be sent to the other device;
process a message containing a second hash of a second shared secret, the message received from the other device;
verify that the received second hash of the second shared secret matches the computed second hash of the first shared secret; and
compute a shared master key from the first shared secret.

25. The device of claim 22, further comprising:
a transceiver coupled to the circuit for sending signals to and receiving signals from another device; and
an antenna coupled to the transceiver for transmitting wireless signals to and receiving wireless signals from the other device.

26. The device of claim 22, further comprising:
a wireline interface coupled to the circuit for sending signals to and receiving signals from another device, the wireline interface adapted for transmitting signals to and receiving signals from the other device over a wireline connection.

27. The device of claim 22, wherein the processor is further adapted to use discrete logarithm algorithm.

28. The device of claim 22, wherein the processor is further adapted to use elliptic curve discrete logarithm.

29. The device of claim 24, wherein the processor is further adapted to compute the first and second hashes of the first shared secret and the first and second hashes of the second shared secret as message authentication check parameters based on a cipher-based message authentication code (CMAC) algorithm.

30. The device of claim 24, wherein the processor is further adapted to compute the first and second hashes of the first shared secret and the first and second hashes of the second shared secret as message authentication check parameters based on a keyed-hash message authentication code (HMAC) algorithm.

31. The device of claim 24, wherein the processor is further adapted to compute the first and second hashes of the first shared secret and the first and second hashes of the second shared secret further using a first nonce selected by the first device, a second nonce selected by the other device, an address of the first device, and an address of the other device.

32. The device of claim 24, wherein the processor is further adapted to send the first hash of the first shared secret to the other device after receiving the second hash of the second shared secret from the other device and verifying that the received second hash of the second shared secret matches the computed second hash of the first shared secret.

33. The device of claim 24, wherein the processor is further adapted to send the first hash of the first shared secret to the other device before receiving the second hash of the second shared secret from the other device.
